(19) United States
(12) Patent Application Publication
(10) Pub. No.: US 2026/0116020 A1
(43) Pub. Date: Apr. 30, 2026

(54) HIGH-TEMPERATURE COMPOSITE ARCHITECTURES AND MANUFACTURING METHODS

(71) Applicant: Continuous Composites Inc., Coeur d'Alen, ID (US)

(72) Inventors: Jacob Daniel SMITH, Spokane, WA (US); Joshua Randles, Mooresville, NC (US)

(73) Assignee: Continuous Composites Inc., Coeur d'Alen, ID (US)

(21) Appl. No.: 19/372,155

(22) Filed: Oct. 28, 2025

Related U.S. Application Data
(60) Provisional application No. 63/712,756, filed on Oct. 28, 2024.

(51) Int. Cl. B29C 70/22; B29K 307/04; B29K 309/02

(52) U.S. Cl. CPC B29C 70/228; B29K 2307/04; B29K 2309/02

(57) ABSTRACT

A method of fabricating a high-temperature composite structure is disclosed. The method may include in situ interlacing a composition-coated reinforcement in a predefined pattern to form a plurality of shingles stacked adjacent each other. The method may also include hardening the composition in the composition-coated reinforcement.

### RELATED APPLICATIONS

This application is based on and claims the benefit of priority from U.S. Provisional Application No. 63/712,756 that was filed on Oct. 28, 2024, the contents of which are expressly incorporated herein by reference.

### TECHNICAL FIELD

The present disclosure relates generally to composite architectures and, more particularly, to methods of manufacturing components having composite architectures adapted for use in high-temperature environments.

### BACKGROUND

Continuous fiber 3D printing (a.k.a., CF3D®) involves the use of continuous fibers that are at least partially coated with a matrix and discharged from a moveable print head. The matrix can be a thermoplastic, a thermoset, a powdered metal, or a combination of any of these and other known matrixes. Upon exiting the print head, a head-mounted cure enhancer (e.g., a UV light, an ultrasonic emitter, a heat source, a catalyst supply, etc.) may be activated to initiate and/or complete curing of the matrix. This curing occurs almost immediately, allowing for unsupported structures to be fabricated in free space without the need for a mold or an autoclave. An example of this technology is disclosed in U.S. Pat. No. 9,511,543 by Tyler that has a priority date of Aug. 29, 2012. CF3D may be inexpensive, fast, and efficient, as the use of molds and manual labor associated with traditional composite manufacturing may be reduced.

One example application for CF3D is in high-temperature environments, where weight, strength, heat resistance, and durability are important considerations. This can include aerospace applications, such as components of a flight or space vehicle. Example applications include leading edges and nose cones.

Historically, high-temperature aerospace components were fabricated using an ablative architecture commonly known in the art as shingling. When constructing a missile nose cone via shingling, a prefabricated tape of woven fibers (e.g., carbon fibers, glass fibers, ceramic fibers, etc.) was wrapped in an overlapping manner around a revolving mandrel. The wraps of the tape were either parallel or perpendicular to an axis of the mandrel. After wrapping was complete, the resin was polymerized via heating, and the nose cone was removed from the mandrel.

Although the traditional methods of shingling may have been adequate for some applications, the tape fibers were often placed incorrectly, distorted during placement, and/or slipped after placement. This improper placement of the fibers produced insufficient and irregular thermal insulation properties and/or resulted in poor resistance to ablation.

An improvement to the traditional shingling process is disclosed in U.S. Pat. No. 5,232,534 that issued to Hocquellet on Aug. 3, 1993 (the '534 patent). The '534 patent discloses machining a groove into an outer surface of a polymerized sublayer, and then inserting and winding a woven tape into the groove using a guide tool. Layers of the tape overlap and are parallel with earlier-placed layers. An angle of each layer is oblique to a surface of the sublayer and defined by a wedge used to support the first layer of wrapping. A bead of matrix is deposited by an injection nozzle into the groove on top of the tape, and another tool is used to form the deposit to a required thickness. The layers of tape and matrix are then polymerized. A rotary machine is used to turn the sublayer and simultaneously advance the various tools in an axial direction during fabrication.

Although the process of the '534 patent may improve accuracy and repeatability of fiber placement, it may still be less than optimal. For example, because the '534 patent still relies on a prefabricated rectangular tape wrapped around a conical sublayer, the fibers in the tape may still deform during wrapping. For example, fibers at an inner radius of each layer may unintentionally bunch up and create a thicker inner edge with undesired porosity. Similarly, fibers at an outer radius of each layer may spread apart from each other and create areas of low-fiber density. Further, fiber orientation may be limited to the existing interlace pattern of a commercially available tape, which may not be optimized for any particular application. And because the process requires formation of a sublayer and thereafter machining of grooves into that sublayer, the process may be slow and expensive.

The disclosed architectures and methods are uniquely configured to address these and other issues of the prior art.

### SUMMARY

In one aspect, the present disclosure is directed to method of fabricating a high-temperature composite structure. The method may include in situ interlacing a composition-coated reinforcement in a predefined pattern to form a plurality of shingles stacked adjacent each other. The method may also include hardening the composition in the composition-coated reinforcement.

In another aspect, the present disclosure is directed to a high-temperature composite component. The high-temperature composite component may include a preform having reinforcements coated with a composition. The reinforcements may be woven in situ into shingles stacked adjacent to each other.

### BRIEF DESCRIPTION OF THE DRAWINGS

FIG. 1 is a diagrammatic illustration of an exemplary disclosed manufacturing system;

FIG. 2 is a diagrammatic illustration of an exemplary disclosed head that may be used in conjunction with the manufacturing system of FIG. 1;

FIG. 3 is an isometric illustration of an exemplary application for the manufacturing system of FIG. 1;

FIG. 4 is a cross-sectional illustration of a portion of the application of FIG. 3;

FIG. 5 is a cross-sectional illustration of an exemplary tool that may be used to form a high-temperature structure;

FIG. 6 is an exploded view illustration of an exemplary portion of the high-temperature structure;

FIG. 7 is an enlarged view isometric illustration of an exemplary architecture of the high-temperature structure;

FIGS. 8, 9, and 10 are a table, diagram, and an isometric view, respectively, illustrating an exemplary pattern that may be used to interlace the architecture of FIG. 7;

FIG. 11 is a pictorial flowchart depicting progression of the interlace pattern of FIGS. 8-10 as layers of the structure are built up to form the architecture of FIG. 7;

FIGS. 12-18 are tables and corresponding isometric illustrations of different interlace patterns that may be used to form the architecture of the high-temperature structure of FIG. 6; and

FIG. 19 is an isometric illustration of another exemplary application for the manufacturing system of FIG. 1.

### DETAILED DESCRIPTION

The terms “about” and/or “generally” as used herein serve to reasonably encompass or describe minor variations in numerical values measured by instrumental analysis or as a result of sample handling. Such minor variations may be considered to be “within engineering tolerances” and in the order of plus or minus 0-10%, 0-5%, or 0-1%, of the numerical values.

The term “substantially” as used herein refers to a majority of, or mostly, as in at least about 50%, 60%, 70%, 80%, 90%, 95%, 96%, 97%, 98%, 99%, 99.5%, 99.9%, 99.99%, or at least about 99.999% or more.

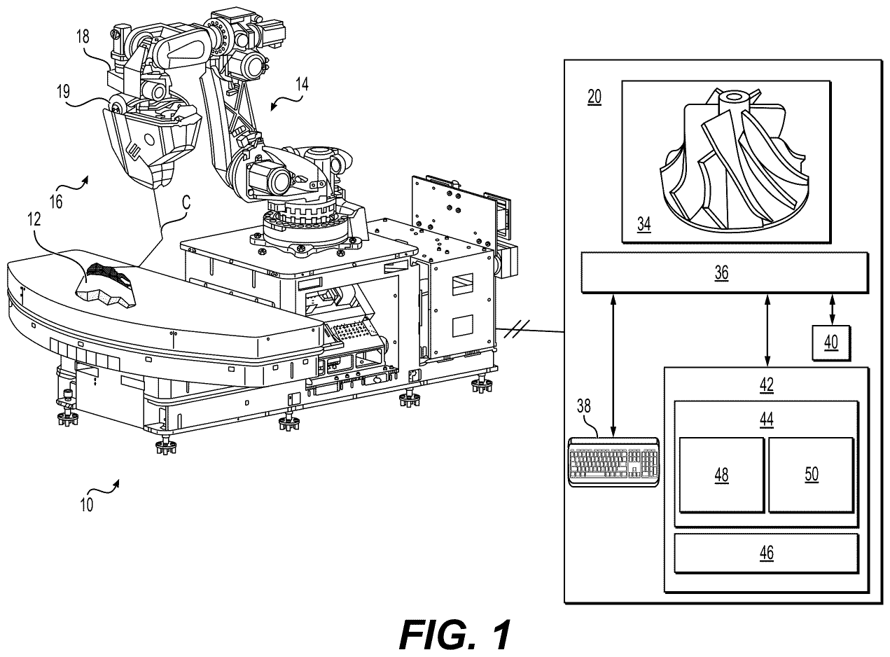

FIG. 1 illustrates an exemplary system 10 that may be used to manufacture a composite structure 12 having any desired shape or size. System 10 may include a support 14 and one or more deposition heads (“head”) 16. Head(s) 16 may be couplable to and moveable by support 14. In the disclosed embodiment of FIG. 1, support 14 is a robotic arm capable of moving head(s) 16 in multiple directions during fabrication of structure 12. Support 14 may alternatively embody a gantry (e.g., an overhead bridge or single-post gantry) or a hybrid gantry/arm also capable of moving head(s) 16 in multiple directions during fabrication of structure 12. Although support 14 is shown as being capable of 6-axis movements, it is contemplated that support 14 may be capable of moving head(s) 16 in a different manner (e.g., along or around a greater or lesser number of axes). In some embodiments, a drive 18 may mechanically couple head(s) 16 to support 14, and include components that cooperate to move portions of and/or supply power or materials to head 16.

Each head 16 may be configured to receive or otherwise contain a resin composition. The composition may include any type of liquid (e.g., a suspension or a solution) that is curable to a solid or semi-solid state (e.g., curable sufficient to hold a green shape of structure 12 during subsequent processing) and/or pyrolyzable into carbon or a ceramic via application of energy (e.g., light, radiation, heat, pressure, chemical catalyst, vibration, magnetic field, etc.). Exemplary compositions include thermosets (e.g., phenolics, furans, (meth) acrylates, epoxies, etc.), pitches, ceramic precursors (e.g., SiC, Si₃N₄, BN, AlN, SiOC, SiCN, BCN, etc.), and others.

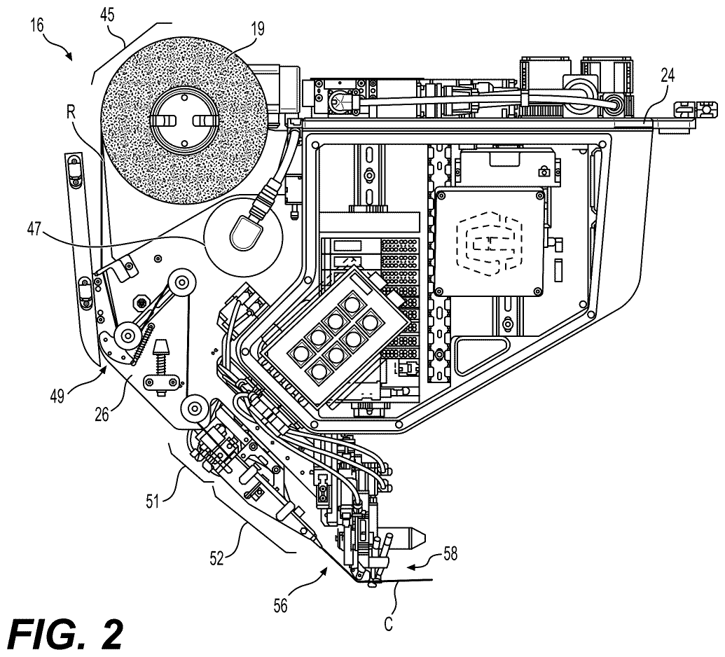

In one embodiment, the composition inside head 16 may be pressurized, for example by an external device (e.g., by an extruder, a pump, etc.—not shown) that is fluidly connected to head 16 via a corresponding conduit (not shown). In another embodiment, however, the pressure may be generated completely inside of head 16 by a similar type of device. In yet other embodiments, the composition may be gravity-fed into and/or through head 16. For example, the composition may be fed into head 16 and pushed or pulled out of head 16 along with one or more continuous reinforcements (shown as R in FIG. 2). The composition and reinforcements, together, may be considered a composite material (shown as C in FIGS. 1 and 2). In some instances, the composition inside head 16 may need to be kept cool and/or dark in order to inhibit premature curing or otherwise obtain a desired rate of curing after discharge. In other instances, the composition may need to be kept warm and/or illuminated for similar reasons. In either situation, head 16 may be specially configured (e.g., insulated, temperature-controlled, shielded, etc.) to provide for these needs.

In some applications, one or more additives may be mixed into the composition at a location upstream of and/or inside of head 16. These additives may be selected to enhance a property of structure 12. For example, the additives may include constituents (e.g., B, Zr, etc.) that increase a thermal operational range of structure 12, constituents (e.g., Fe, Co, Ni, etc.) that increase a magnetic property of structure 12, constituents (e.g., ferrous materials) that enhance the action of pyrolysis, and/or constituents (e.g., Cu, Pd, Pt, etc.) that increase a catalytic property of structure 12.

The composition (i.e., with or without any additives) may be used to coat any number of reinforcements that enhance a mechanical property of structure 12, including continuous reinforcements and discontinuous reinforcements. For the purposes of this disclosure, continuous reinforcements may be considered to have an aspect ratio (V) defined as a length (L) divided by a diameter (d) (e.g., V=L/d) that is greater than 10, 100, 1000, 100,000, 1,000,000 or even larger. Discontinuous reinforcements may include reinforcements having an aspect ratio less than that of continuous reinforcements.

The reinforcements may be supplied in the form of powder, particles, chopped fibers, unchopped fibers, tows, braids, rovings, fabrics, knits, mats, socks, sheets, tubes, etc. of material that, together with the composition, make up a composite portion (e.g., a wall) of structure 12. The reinforcements may be stored within or otherwise passed through head 16 (e.g., fed from one or more spools or hoppers—not shown). When multiple reinforcements are simultaneously used, the reinforcements may be of the same material and have the same sizing and cross-sectional dimension and shape, or a different material with different sizing and/or cross-sectional dimension and shape. The sizing may include, for example, treatment of the reinforcement with plasma, treatment with an acid (e.g., nitric acid), or otherwise surface-functionalized with an agent (e.g., a dialdehyde, an epoxy, a vinyl, and/or another functional group) to enhance adhesion of the composition to the reinforcement. It should be noted that the term “reinforcement” is meant to encompass both structural and non-structural (e.g., functional) types of materials that are at least partially encased in the composition discharging from head 16.

The reinforcements may be opaque (e.g., partially or completely opaque) to a cure energy, transparent (e.g., partially or completely transparent) to the cure energy, and/or a mixture of opaque and transparent materials. The reinforcement materials may include, for example, carbon fibers, graphite fibers, graphene fibers, resorcinol-formaldehyde blends, asbestos fibers, Kevlar fibers, polybenzimidazole fibers, polysulforamide fibers, glass fibers, poly (phenylene oxide) fibers, vegetable fibers, wood fibers, mineral fibers, plastic fibers, metallic wires, optical tubes, aramid fibers, polyacrylonitrile, rayon, petroleum pitch, natural pitch, resoles, carbon nanotubes, carbon soot, creosote, SiC, boron, WC, butyl rubber, boron nitride, fumed silica, nanoclay, silicon carbide, boron nitride, zirconium oxide, titanium dioxide, chalk, calcium sulfate, barium sulfate, calcium carbonate, silicates (e.g., talc, mica or kaolin, silicas, aluminum hydroxide, magnesium hydroxide, etc.), organic reinforcements (e.g., polymer powders, polymer fibers, etc.), and mixtures thereof.

In one example, the composition may be a carbon precursor (e.g., pyrolyzable to carbon) and used to coat carbon reinforcements, a mixture of carbon and non-carbon reinforcements, ceramic reinforcements, and/or a mixture of ceramic and non-ceramic reinforcements. In another example, the composition may be a ceramic precursor and used to coat carbon reinforcements, a mixture of carbon and non-carbon reinforcements, ceramic reinforcements, and/or a mixture of ceramic and non-ceramic reinforcements. In some situations, non-carbon and/or non-ceramic reinforcements may be selectively used in conjunction with carbon and/or ceramic reinforcements for purposes of creating conduits that enhance saturation of the carbon and/or ceramic reinforcements with the composition.

The reinforcements may be exposed to (e.g., at least partially coated with) the composition while the reinforcements are inside head 16, while the reinforcements are being passed to head 16, and/or while the reinforcements are discharging from head 16. The composition, dry (e.g., unimpregnated) reinforcements, and/or reinforcements that are already exposed to the composition (pre-impregnated reinforcements) may be transported into head 16 in any manner apparent to one skilled in the art. In some embodiments, discontinuous reinforcements (e.g., powder, nano-particles or tubes, chopped fibers, etc.) may be mixed with the composition and/or additives before and/or after the composition coats continuous reinforcements.

One or more cure enhancers (e.g., a light source, a radiation source, an ultrasonic emitter, a microwave generator, a magnetic field generator, a heater, a catalyst dispenser, etc.) 18 may be mounted proximate (e.g., within, on, and/or adjacent) head 16 and configured to affect (e.g., initiate, enhance, complete, or otherwise facilitate) curing of the composition as it is discharged with the reinforcement(s) from head 16. Each cure enhancer 18 may be independently and/or cooperatively controlled to selectively expose one or more portions of the discharging material to cure energy (e.g., electromagnetic radiation, vibrations, heat, a chemical catalyst, etc.). The energy may trigger a reaction to occur within the composition, increase a rate of the reaction, sinter the composition, pyrolize the composition, harden the composition, stiffen the composition, or otherwise cause the composition to partially or fully cure and/or char as it discharges from head 16. The amount of energy produced by cure enhancer 18 may be sufficient to at least partially cure the composition before structure 12 axially grows more than a predetermined length away from head 16. In one embodiment, structure 12 is cured sufficient to hold its shape before the axial growth length becomes equal to an external diameter of the composition-coated reinforcement.

The composition and/or reinforcement may be discharged from head 16 via one or more different modes of operation. In a first exemplary mode of operation, the composition and/or reinforcement are extruded (e.g., pushed under pressure and/or mechanical force) from head 16 as head 16 is moved by support 14 to create the 3-dimensional trajectory within a longitudinal axis of the discharging material. In a second exemplary mode of operation, at least the reinforcement is pulled from head 16, such that a tensile stress is created in the reinforcement during discharge. In this mode of operation, the composition may cling to the reinforcement and thereby also be pulled from head 16 along with the reinforcement, and/or the composition may be discharged from head 16 under pressure along with the pulled reinforcement. In the second mode of operation, where the reinforcement is pulled from head 16, the resulting tension in the reinforcement may increase a strength of structure 12 (e.g., by aligning the reinforcements, inhibiting buckling, disbursing loading, etc.), while also allowing for a greater length of unsupported structure 12 to have a straighter trajectory. That is, the tension in the reinforcement remaining after curing of the composition may act against the force of gravity (e.g., directly and/or indirectly by creating moments that oppose gravity) to provide support for structure 12.

The reinforcement may be pulled from head 16 as a result of head 16 being moved by support 14 away from an anchor (e.g., a print bed, a table, a floor, a wall, an existing surface of structure 12, etc.). For example, at the start of structure formation, a length of matrix-impregnated reinforcement may be pulled and/or pushed from head 16, deposited against the anchor, and at least partially cured, such that the discharged material adheres (or is otherwise coupled) to the anchor. Thereafter, head 16 may be moved away from the anchor (e.g., via controlled regulation of support 14), and the relative movement may cause the reinforcement to be pulled from head 16. It should be noted that the movement of reinforcement through head 16 could be assisted (e.g., via one or more internal feed mechanisms), if desired. However, the discharge rate of reinforcement from head 16 may primarily be the result of relative movement between head 16 and the anchor, such that tension is created within the reinforcement. It is contemplated that the anchor could be moved away from head 16 instead of or in addition to head 16 being moved away from the anchor.

Any number of separate computing devices 20 may be used to design and/or control placement of the composite material within structure 12 and/or to analyze performance characteristics of structure 12 before, during, and/or after formation. Computing device 20 may include, among other things, a display 34, one or more processors 36, any number of input/output (“I/O”) devices 38, any number of peripherals 40, and one or more memories 42 for storing programs 44 and data 46. Programs 44 may include, for example, any number of design and/or printing apps 48 and an operating system 50.

Display 34 of computing device 20 may include a liquid crystal display (LCD), a light emitting diode (LED) screen, an organic light emitting diode (OLED) screen, and/or another known display device. Display 34 may be used for presentation of data under the control of processor 36.

Processor 36 may be a single or multi-core processor configured with virtual processing technologies and use logic to simultaneously execute and control any number of operations. Processor 36 may be configured to implement virtual machine or other known technologies to execute, control, run, manipulate, and store any number of software modules, applications, programs, etc. In addition, in some embodiments, processor 36 may include one or more specialized hardware, software, and/or firmware modules (not shown) specially configured with particular circuitry, instructions, algorithms, and/or data to perform functions of the disclosed methods. It is appreciated that other types of processor arrangements could be implemented that provide for the capabilities disclosed herein.

Memory 42 can be a volatile or non-volatile, magnetic, semiconductor, tape, optical, removable, non-removable, or other type of storage device or tangible and/or non-transitory computer-readable medium that stores one or more executable programs 44, such as analysis and/or printing apps 48 and operating system 50. Common forms of non-transitory media include, for example, a flash drive, a flexible disk, a hard disk, a solid state drive, magnetic tape or other magnetic data storage medium, a CD-ROM or other optical data storage medium, any physical medium with patterns of holes, a RAM, a PROM, an EPROM, a FLASH-EPROM or other flash memory, NVRAM, a cache, a register or other memory chip or cartridge, and networked versions of the same.

Memory 42 may store instructions that enable processor 36 to execute one or more applications, such as design and/or fabrication apps 48, operating system 50, and any other type of application or software known to be available on computer systems. Alternatively or additionally, the instructions, application programs, etc. can be stored in an internal and/or external database (e.g., a cloud storage system—not shown) that is in direct communication with computing device 20, such as one or more databases or memories accessible via one or more networks (not shown). Memory 42 can include one or more memory devices that store data and instructions used to perform one or more features of the disclosed embodiments. Memory 42 can also include any combination of one or more databases controlled by memory controller devices (e.g., servers, etc.) or software, such as document management systems, Microsoft SQL databases, SharePoint databases, Oracle™ databases, Sybase™ databases, or other relational databases.

In some embodiments, computing device 20 is communicatively connected to one or more remote memory devices (e.g., remote databases—not shown) through a network (not shown). The remote memory devices can be configured to store information that computing device 20 can access and/or manage. By way of example, the remote memory devices could be document management systems, Microsoft SQL database, SharePoint databases, Oracle databases, Sybase databases, Cassandra, HBase, or other relational or non-relational databases or regular files. Systems and methods consistent with disclosed embodiments, however, are not limited to separate databases or even to the use of a database.

Programs 44 may include one or more software or firmware modules causing processor 36 to perform one or more functions of the disclosed embodiments. Moreover, processor 36 can execute one or more programs located remotely from computing device 20. For example, computing device 20 can access one or more remote programs that, when executed, perform functions related to disclosed embodiments. In some embodiments, program(s) 44 stored in memory 42 and executed by processor 36 can include one or more of design, fabrication, and/or analysis apps 48 and operating system 50. Apps 48 may cause processor 36 to perform one or more functions of the disclosed methods.

Operating system 50 may perform known operating system functions when executed by one or more processors such as processor 36. By way of example, operating system 50 may include Microsoft Windows, Unix, Linux, OSX, IOS, Raspberry Pi OS (e.g., Rapbian), Android, or another type of operating system 50. Accordingly, disclosed embodiments can operate and function with computer systems running any type of operating system 50.

I/O devices 38 may include one or more interfaces for receiving signals or input from a user and/or system 10, and for providing signals or output to system 10 (e.g., to support 14 and/or head 16) that allow structure 12 to be printed. For example, computing device 20 can include interface components for interfacing with one or more input devices, such as one or more keyboards, mouse devices, and the like, which enable computing device 20 to receive input from a user.

Peripheral device(s) 40 may be standalone devices or devices that are embedded within or otherwise associated with system 10 and used during fabrication of structure 12. Example peripherals can include input devices (e.g., one or more sensors, such as tension sensors, position sensors, pressure sensors, temperature sensors, proximity sensors, level sensors, rotary encoders, scanners, potentiometers, and other sensors known in the art) and/or output devices (e.g., one or more actuators, such as a matrix supply, a reinforcement (e.g., fiber) supply, a heater, a pump, cure enhancer 22, a positioning motor, a cutter, a feed roller, a tensioner, a wetting mechanism, a compactor, etc.). In some embodiments, peripheral device(s) 40 may, themselves, include one or more processors (e.g., a programmable logic control (PLC), a computer numeric controller (CNC), etc.), a memory, and/or a transceiver. When peripheral device(s) 40 are equipped with a dedicated processor and memory, the dedicated processor may be configured to execute instructions stored on the memory to receive commands from processor 36 associated with video, audio, other sensory data, control data, location data, etc., including capture commands, processing commands, motion commands, and/or transmission commands. The transceiver may include a wired or wireless communication device capable of transmitting data to or from one or more other components in system 10. In some embodiments, the transceiver can receive data from processor 36, including instructions for sensor and/or actuator activation and for the transmission of data via the transceiver. In response to the received instructions, the transceiver can packetize and transmit data between processor 36 and the other components.

Design, fabrication, and/or analysis apps 48 may cause computing device 20 to perform methods related to generating, receiving, processing, analyzing, storing, and/or transmitting data in association with operation of system 10 and corresponding design/fabrication/analysis of structure 12. For example, apps 48 may be able to configure computing device 20 to perform operations including: displaying a graphical user interface (GUI) on display 34 for receiving design/control instructions and information from the operator of system 10; capturing sensory data associated with system 10 (e.g., via peripherals 40A); receiving instructions via I/O devices 38 and/or the user interface regarding specifications, desired characteristics, and/or desired performance of structure 12; processing the control instructions; generating one or more possible designs of and/or plans for fabricating structure 12; analyzing and/or optimizing the designs and/or plans; providing recommendations of one or more designs and/or plans; controlling system 10 to fabricate a recommended and/or selected design via a recommended and/or selected plan; analyzing the fabrication; and/or providing feedback and adjustments to system 10 for improving future fabrications.

An example head 16 is disclosed in greater detail in FIG. 2. As can be seen in this figure, head 16 may include a mounting arrangement that is configured to hold, enclose, contain, and/or otherwise provide mounting for the remaining components of head 16. The mounting arrangement may include, among other things, an upper generally horizontal plate 24 (e.g., upper as viewed from the perspective of FIG. 2) and one or more generally vertical plates 26 (e.g., lower plates) that intersect orthogonally with upper plate 24. The other components of head 16 may be mounted to a front or back of lower plate(s) 26 and/or to a top or bottom side of upper plate 24. As will be explained in more detail below, some components may extend downward past a terminal end of lower plate(s) 26. Likewise, some components may extend transversely from lower plate(s) 26 past outer edges of upper plate 24.

Upper plate 24 may be generally rectangular (e.g., square), while lower plate 26 may be elongated and/or tapered to have a triangular shape. Lower plate 26 may have a wider proximal end rigidly connected to a general center of upper plate 24 and a narrower distal end that is cantilevered from the proximal end. Coupler 18 (referring to FIG. 1) may be connected to upper plate 24 at a side opposite lower plate(s) 26 and used to quickly and releasably connect head 16 to support 14. One or more racking mechanisms (e.g., handles, hooks, eyes, etc.—not shown) may be located adjacent coupler 18 and used to rack head 16 (e.g., during tool changing) when head 16 is not connected to support 14.

Any number of components of head 16 may be mounted to lower plate 26. For example, a reinforcement supply module 45, a composition supply module 47, a tensioning module 49, a clamping module 51, a wetting module 52, a cutting module 56, and a compacting/curing module 58 may be operatively mounted to lower plate 26. It should be noted that other mounting arrangements may also be possible. Head 16 is disclosed in greater detail in U.S. Patent Publication 2023/0073782 that was filed on Sep. 2, 2022 (the '782 publication) and that is incorporated herein by reference.

As explained in the '782 publication, the reinforcement may pay out from module 45 (from a spool mounted to creel 19), pass through and be tension-regulated by module 49, and thereafter be wetted with the composition in and discharged through module 52 (e.g., as supplied by module 47). After discharge, the composition-wetted reinforcement may be selectively severed via module 56 (e.g., while being held stationary by module 51) and thereafter compacted and/or cured by module 58.

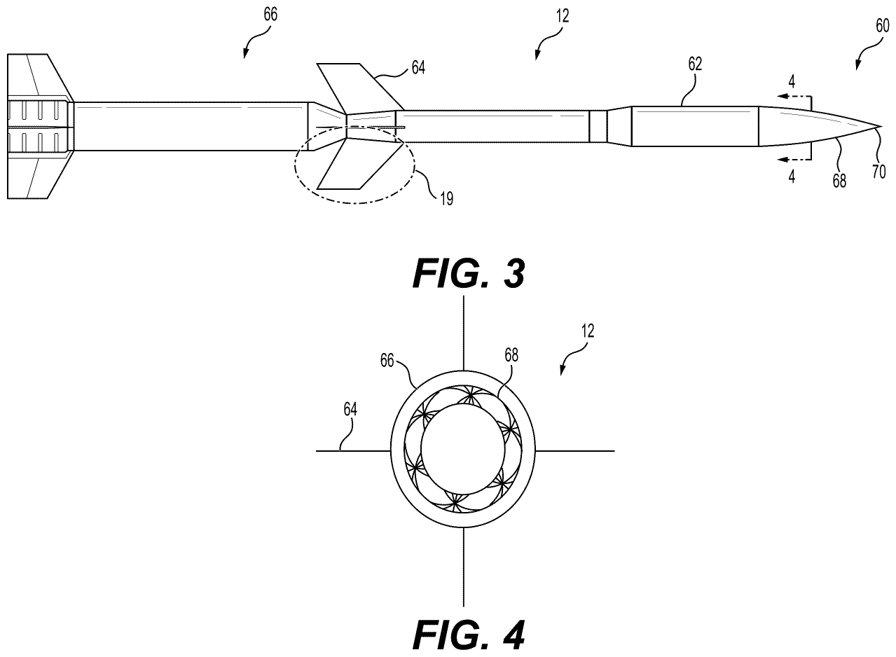

FIGS. 3 and 4 illustrate an exemplary structure 12 that can be manufactured by system 10 (referring to FIG. 1). In this embodiment, structure 12 is an aerial vehicle (e.g., a manned or unmanned vehicle such as a commercial jet, a drone, a missile, a rocket, etc.) having, among other things, a nose 60, a body 62, one or more airfoils (e.g., fins, vanes, wings, tails, blades, rudders, stabilizers, etc.) 64, and an engine 66. Although multiple different portions of these components may be exposed to high temperatures, particularly when the vehicle is operating at hypersonic speeds, this disclosure will focus primarily on the fabrication of nose 60. It should be noted, however, that some or all of the concepts discussed below as associated with fabrication of nose 60 may similarly be utilized to fabricate some or all of the other components (e.g., leading edges of airfoils 64 or a nozzle of engine 66) of structure 12, if desired. It is also contemplated that structure 12 may have more, fewer, and/or different components than those listed above.

In some applications, nose 60 is a monolithic composite structure. In other applications, however, nose 60 may be a subassembly that includes a cone 68 and a separate tip 70 that is mounted at a leading end of cone 68. In these other applications, cone 68 and tip 70 may be fabricated from different materials and/or via different processes, and thereafter joined together (e.g., via adhesion, threading, mechanical fasteners, etc.). For example, cone 68 may be fabricated via CF3D as a CBFC or a CMC, while tip 70 may be metallic and fabricated via an additive or subtractive process. Only fabrication of cone 68 will be described in detail in this disclosure.

As is known in the art, the processes of CBFC and CMC may involve multiple steps. A description of these steps is disclosed in U.S. Pat. No. 11,548,220 that issued on Jan. 10, 2023 and that is incorporated herein by reference. These steps may include, among other things, discharging composite material from head 16 to produce a three-dimensional preform (e.g., a frustoconical preform of carbon or ceramic fibers at least partially coated in and/or internal wetted with a ceramic or carbon precursor composition). The preform may be fabricated to have a desired net or near-net shape of structure 12. As the material discharges from head 16, the composition may be at least partially cured (e.g., stiffened sufficient to hold its shape, location and/or orientation) by exposure to energy from the cure enhancer(s) of module 58. In some embodiments, the composition (e.g., a thixotropic resin) may become thick enough after discharge to hold its shape without needing to be cured by the enhancer(s). In these embodiments, the initial step of curing may be omitted, if desired.

After the preform has been fabricated, the preform may selectively be densified. For example, a densifying material (e.g., a carbon or ceramic precursor) may be introduced to the preform as a liquid and/or a gas. The densifying material may be the same as the composition originally used to fabricate the preform or a different composition, as desired. The densifying material may adhere to the previously discharged material and fill voids therein and/or therebetween. Heat and/or pressure may be utilized to enhance infiltration of the densifying material into the voids and spaces of the preform.

After the application of densifying material, the preform may be pyrolized. That is, the preform and the added densifying material may be exposed to elevated temperatures (e.g., to temperatures of about 400-3000° C., such as 400-500° C. or 500-1500° C.) that causes the densifying material to carbonize into char or transform into ceramic.

Without wishing to be bound by any theory, carbonization due to pyrolysis may include polymerization and growth of the composition, which results in desirable carbon or ceramic enrichment of the preform. It should be noted that pyrolization may be enhanced when performed within a controlled environment (e.g., in the absence of oxygen).

As the preform is heated (e.g., with or without the densifying material), the associated composition and/or densifying material may shrink, crack, or otherwise become porous. In order to provide a desired final density to structure 12, multiple cycles of material application and pyrolyzing may be required. Any number of these cycles may be implemented.

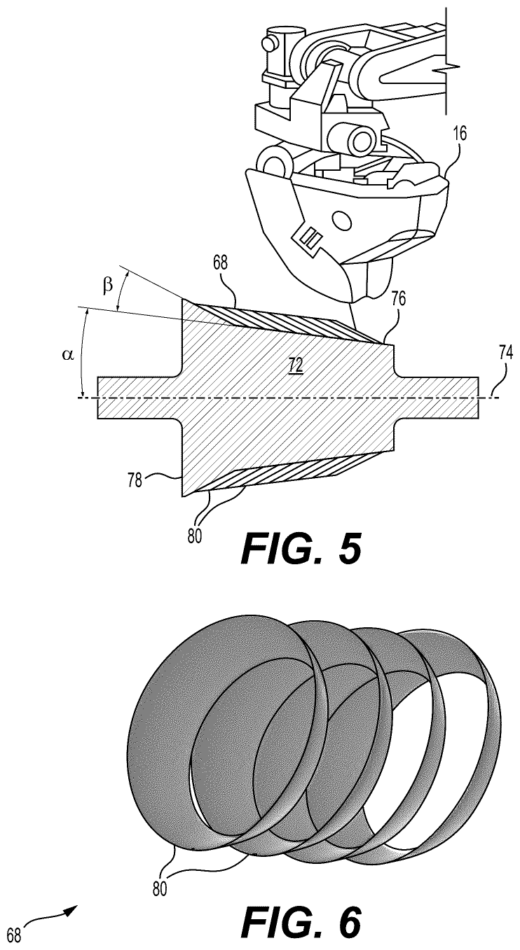

FIGS. 5 and 6 illustrate an exemplary way to fabricate the preform of cone 68. In this example, head 16 is shown as discharging composite material onto a tool 72. Tool 72 may be a specially adapted rotary tool (e.g., a mandrel) designed for fabricating cone 68. As material is discharged from head 16, one or both of head 16 and tool 72 may move. For example, head 16 may translate in one, two, or three dimensions and/or tool 72 may rotate about an axis 74. It may also be possible for tool 72 to translate in an axial direction in addition to or instead of rotating, if desired. Likewise, it may be possible for head 16 to rotate (e.g., in addition to or instead of translating) about any number of axes during fabrication of structure 12, if desired.

Tool 72 may have a generally conical outer surface 76 that tapers from a base end towards a tip end. In one embodiment, an angle α of this taper may be about 5-10° relative to axis 74 (e.g., about 5-8° or about 7°). An annular starting wedge (e.g., an integral or separate wedge) 78 may be located at the base end. An outer surface of wedge 78 may taper relative to surface 76 and axis 74. In one embodiment, an angle β of this taper may be about 10-30° relative to surface 76 (e.g., about 13°) or about 15-40° relative to axis 74 (e.g., about) 20°.

As will be explained in more detail below, the preform of cone 68 may be fabricated by depositing composite material onto wedge 78 in overlapping annular layers 80. Each layer 80 may be placed adjacent to another layer 80 (e.g., nested), starting from the base end of tool 72 and ending at or near the tip end. In the disclosed embodiments, layers 80 have generally consistent thicknesses and generally consistent radial widths (i.e., differences between inner and outer annular diameters), although this need not always be true. Regardless of the thicknesses of layers 80, each successive layer 80 applied to tool 70 may have gradually reducing inner and outer diameters, such that the conical shape of cone 68 is formed.

It should be noted that the composite material may be applied to only the annular surface of wedge 78, or to both the annular surface of wedge 78 and some portion of conical surface 76. For example, the material may extend a short axial distance along surface 76 (e.g., only an axial distance equal to a thickness of each layer 80—shown in FIG. 5) or a longer axial distance (e.g., a length equal to multiple layer thicknesses or an entire axial length of surface 76), as desired.

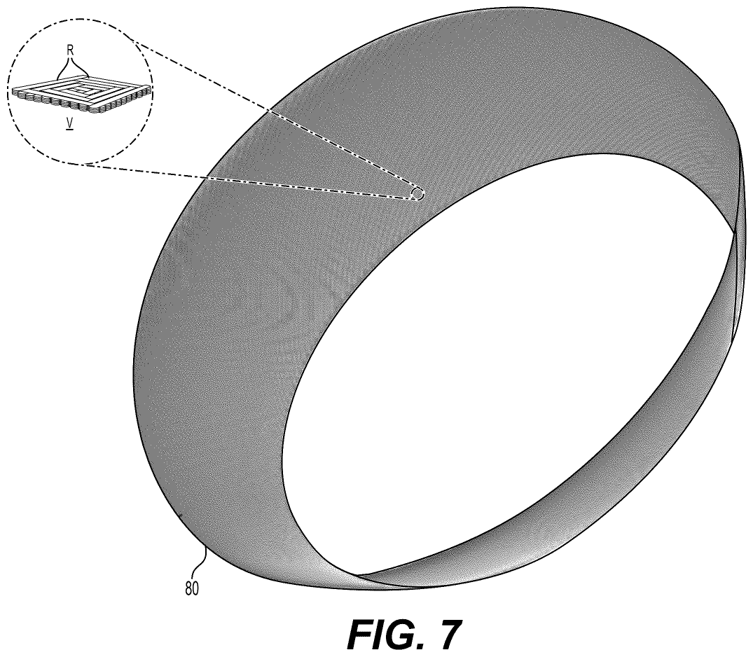

As illustrated in FIG. 7, each annular layer 80 may be formed by selectively interlacing in situ any number of reinforcements R in a predefined pattern (a full representation of the pattern is shown as a voxel V in FIG. 7). In the depicted embodiment, the predefined pattern may be repeated around the annular surface of a given layer 80 (e.g., end-to-end and/or side-to-side in a continuous manner) to produce a uniformly distributed network of connected voxels. In some applications, a given pattern of interlacing is not repeated within a thickness of a given layer 80 (e.g., in a direction substantially orthogonal to a surface of a given layer). Instead, in some applications, a conic boundary between adjacent layers 80 may be at least partially defined by repetition of the pattern. It is also contemplated that adjacent layers 80 may be fabricated using different patterns, if desired.

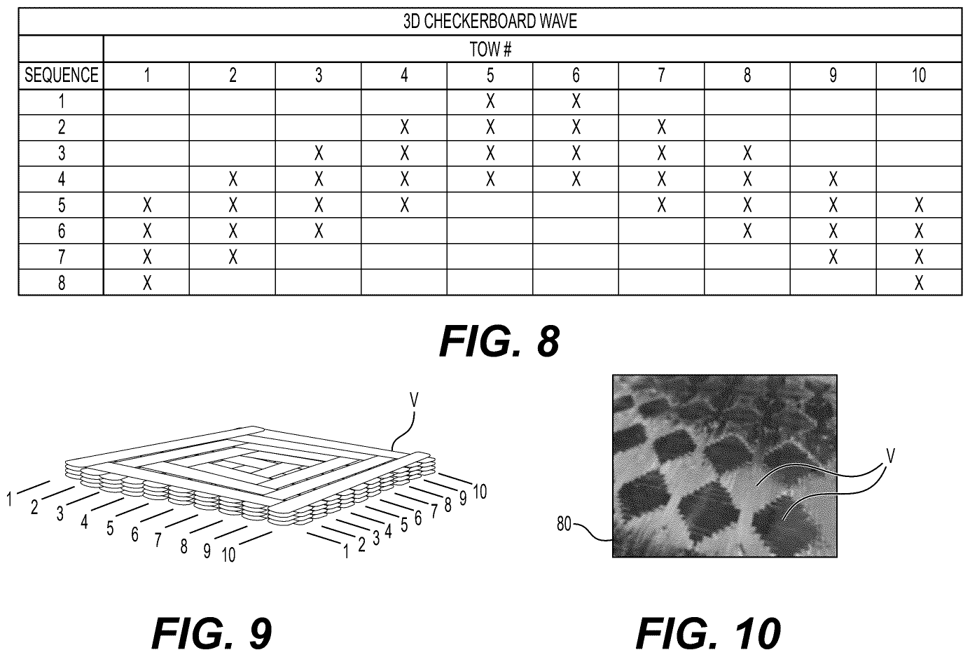

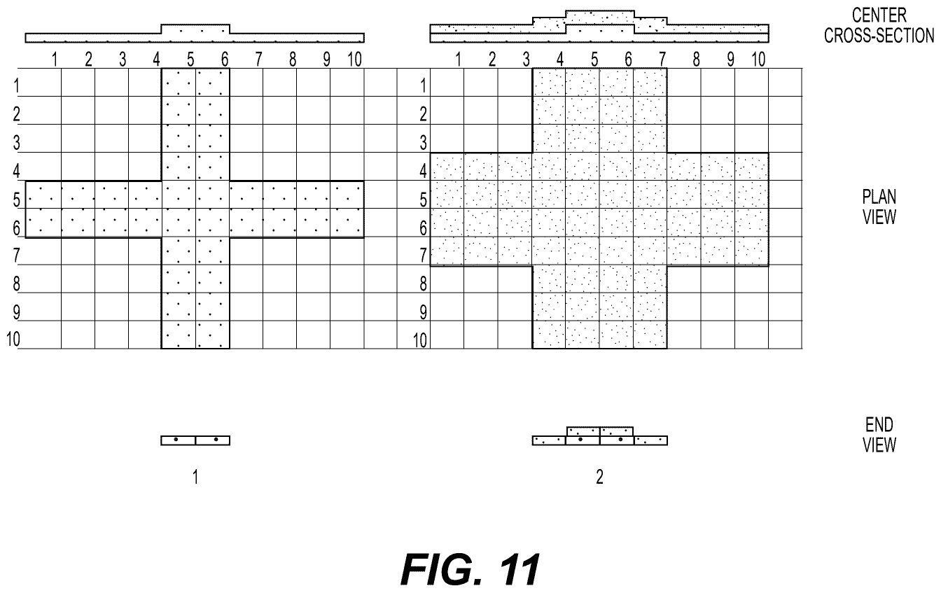

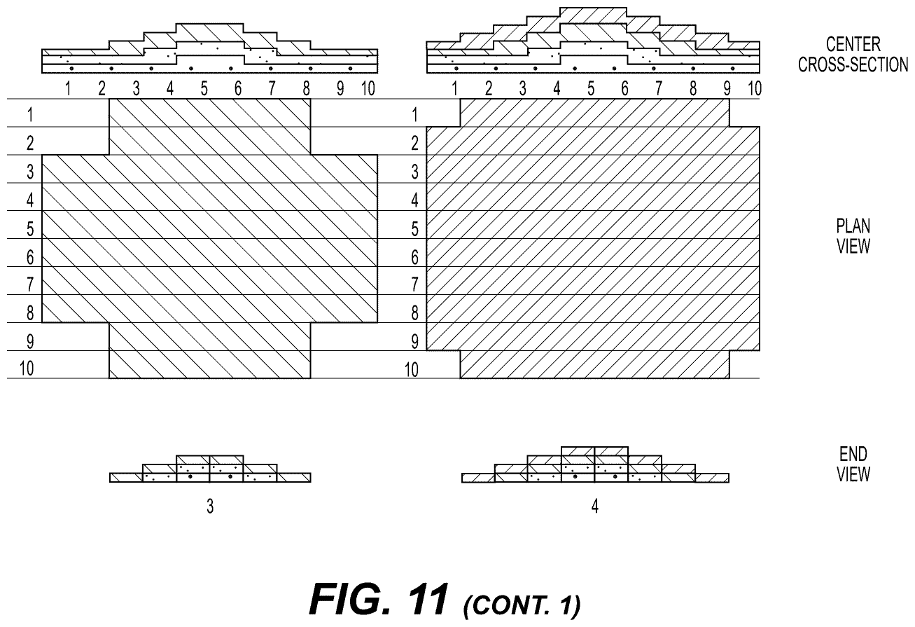

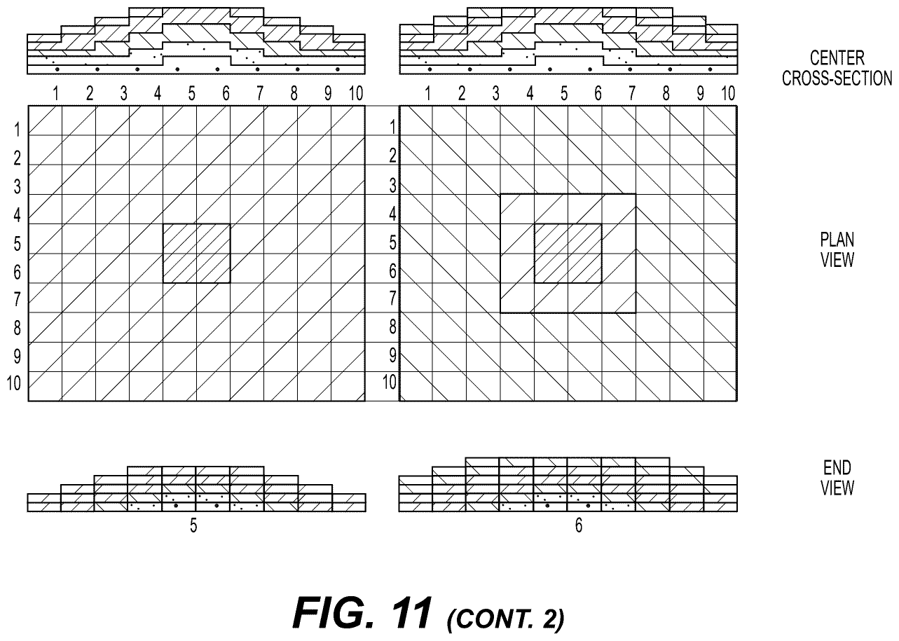

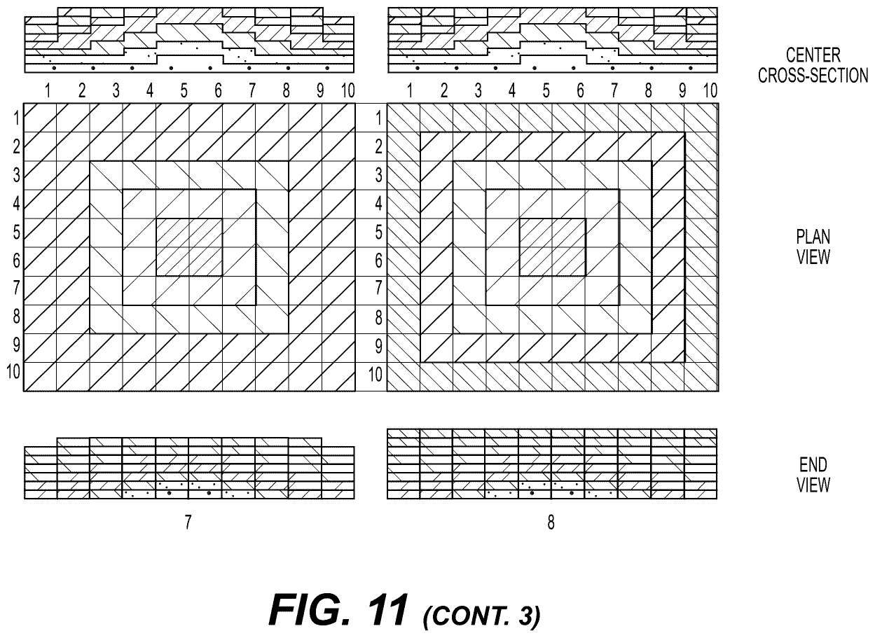

FIGS. 8, 9, 10, and 11 illustrate an exemplary voxel pattern that can be repeated to form the distributed network of an exemplary layer 80. FIG. 8 provides a recipe for creating the pattern, while FIGS. 9 and 10 illustrate isometric views (e.g., a top isometric view and a bottom isometric view, respectively) of a completed pattern. FIG. 11 illustrates different sequences of material deposition required to build up a complete the voxel pattern using the recipe of FIG. 8. For the purposes of this disclosure, this pattern may be referred to as a 3D Checkerboard Wave Pattern due to the appearance of layer 80 as a checkerboard when viewed from a back side (see FIG. 10) and the fact that the reinforcements resemble waves in a thickness direction of layer 80 (see FIG. 9).

As can be seen in FIGS. 9 and 10, each voxel of structure 12 may be fabricated from ten columns and ten rows of reinforcements (e.g., tows of fibers). It should be noted that, while the columns and rows are shown in FIGS. 9 and 10 as being generally orthogonal to each other, this is not a requirement. Any angle may be utilized. It should also be noted that this pattern may be adapted for a voxel having a greater or lesser number of columns and rows, as desired. Additionally, it may be possible for the different ply directions to have the same or a different number of tows (i.e., for the columns to have a greater or lesser number than the rows), if desired. For the purposes of explanation, the columns and rows of tows are numbered sequentially (e.g., from left to right in the perspective of FIG. 9).

As shown in FIG. 8, a first sequence of material deposition may include depositing columns and then rows of reinforcement tows corresponding to positions 5 and 6 in the image of FIG. 9. This sequence is also depicted as sequence-1 in FIG. 11. The first two tows that are placed into columns 5 and 6 may be placed parallel and adjacent to each other (e.g., without significant spacing between or overlapping) to fill a center columnar section of the voxel. The second two tows that are placed into rows 5 and 6 are likewise placed parallel and adjacent to each other fill a center lateral section of the voxel.

As shown in the center image of sequence-1 (referring to FIG. 11), the tows in rows 5 and 6 may cross over the tows in columns 5 and 6 at the general center of the voxel. Accordingly, the center of the voxel, after completion of the first sequence, may have a thickness of two stacked reinforcements (see center cross-section shown in the uppermost image of sequence-1), while the ends extending away from the center may have a thickness of only a single reinforcement (see end cross-section shown in the lowest image of sequence-1). It should be noted that, while the cross-sections correspond to views cut through the deposited tows from left-to-right in the perspective of FIG. 11, views cut from top to bottom would appear identical due to the symmetrical nature of the voxel pattern.

The second sequence of material deposition may include depositing columns and thereafter rows of reinforcements corresponding to positions 4-7 in the image of FIG. 9. This corresponds with sequence-2 in the table of FIG. 8 and in the image depicted in FIG. 11. Again, the tows that are placed into columns 4-7 may be placed parallel and adjacent to each other and centered at the center columnar section of the voxel. The tows that are placed into rows 4-7 are likewise placed parallel and adjacent and together are laterally centered within the voxel.

As shown in the images of sequence-2 (referring to FIG. 11), rows 4-7 may cross over columns 4-7 at the general center of the voxel. Accordingly, the center of the voxel, after completion of the second sequence, may have a thickness of four stacked reinforcements at the center and step down one reinforcement at a time moving away from the center. The tows in rows and columns 5 and 6 may have a thickness of two stacked reinforcements at their ends, while the tows in rows and columns 4 and 7 may have a thickness of only a single reinforcement at their ends.

The third sequence of material deposition may include depositing columns and thereafter rows of reinforcements corresponding to positions 3-8 in the image of FIG. 9. This corresponds with sequence-3 depicted in FIG. 11. Again, the tows that are placed into columns 3-8 may be placed parallel and adjacent to each other and centered at the center columnar section of the voxel. The tows that are placed into rows 3-8 are likewise placed parallel and adjacent and together are laterally centered within the voxel.

As shown in the images of sequence-3, rows 3-8 may cross over columns 3-8 at the general center of the voxel. Accordingly, the center of the voxel, after completion of the third sequence, may have a thickness of six stacked reinforcements and step down one layer at a time moving away from the center. The tows in rows and columns 5 and 6 may have a thickness of three stacked reinforcements at their ends; the tows in rows and columns 4 and 7 may have a thickness of two stacked reinforcements at their ends; and the tows in rows and columns 3 and 8 may have a thickness of only a single reinforcement.

The fourth sequence of material deposition may include depositing columns and thereafter rows of reinforcements corresponding to positions 2-9 in the image of FIG. 9. This corresponds with sequence-4 depicted in FIG. 11. Again, the tows that are placed into columns 2-9 may be placed parallel and adjacent to each other and centered at the center columnar section of the voxel. The tows that are placed into rows 2-9 are likewise placed parallel and adjacent and together are laterally centered within the voxel.

As shown in the images of sequence-4, rows 2-9 may cross over columns 2-9 at the general center of the voxel. Accordingly, the center of the voxel, after completion of the third sequence, may have a thickness of eight stacked reinforcements and step down one reinforcement at a time moving away from the center. The tows in rows and columns 5 and 6 may have a thickness of four stacked reinforcements at their ends; the tows in rows and columns 4 and 7 may have a thickness of three stacked reinforcements at their ends; the tows in rows and columns 3 and 8 may have a thickness two stacked reinforcements at their ends; and the tows in rows and columns 2 and 9 may have a thickness of only a single reinforcement.

The fifth sequence of material deposition may include depositing columns and thereafter rows of reinforcements corresponding to positions 1-4 and 7-10 in the image of FIG. 9. This corresponds with sequence-5 depicted in FIG. 11. In contrast to the previous four sequences, in sequence-5 the tows of both rows and columns are separated into two parallel and spaced-apart groups located at opposing sides of the voxel's center. The tows within each grouping are adjacent to each other.

As shown in the images of sequence-5, rows 1-4 and 7-10 may cross over columns 1-4 and 7-10 at the voxel's sides. Accordingly, the center of the voxel, after completion of the fifth sequence, does not increase in thickness. The tow-ends associated with rows and columns 5 and 6 increase in thickness by one reinforcement, while the ends of all other tows increase in thickness by two reinforcements.

The sixth sequence of material deposition may include depositing columns and thereafter rows of reinforcements corresponding to positions 1-3 and 8-10 in the image of FIG. 9. This corresponds with sequence-6 depicted in FIG. 11. Like sequence-5, the tows of both rows and columns in sequence-6 are separated into two parallel and spaced-apart groups located at opposing sides of the voxel's center. The tows within each grouping are adjacent to each other.

As shown in the images of sequence-6, rows 1-3 and 8-10 may cross over columns 1-3 and 8-10 at the voxel's sides. Accordingly, the center of the voxel, after completion of the sixth sequence, does not increase in thickness. The tow-ends associated with rows and columns 4-7 increase in thickness by one reinforcement, while the ends of all other tows increase in thickness by two reinforcements.

The seventh sequence of material deposition may include depositing columns and thereafter rows of reinforcements corresponding to positions 1, 2, 9, and 10 in the image of FIG. 9. This corresponds with sequence-7 depicted in FIG. 11. Like sequences-5 and -6, the tows of both rows and columns in sequence-7 are separated into two parallel and spaced-apart groups located at opposing sides of the voxel's center. The tows within each grouping are adjacent to each other.

As shown in the images of sequence-7, rows 1, 2, 9, and 10 may cross over columns 1, 2, 9, and 10 at the voxel's sides. Accordingly, the center of the voxel, after completion of the seventh sequence, does not increase in thickness. The tow-ends associated with rows and columns 3-8 increase in thickness by one reinforcements, while the ends of all other tows increase in thickness by two reinforcements.

The eighth and final sequence of material deposition may include depositing material in columns-1 and -10 and thereafter in rows-1 and -10. This corresponds with sequence-8 depicted in FIG. 11. Like sequences-5, -6, and 7, the tows of both rows and columns in sequence-8 are separated at opposing sides of the voxel's center and parallel. No tows are placed adjacent to each other in sequence-8.

As shown in the images of sequence-8, rows 1 and 10 may cross over columns 1 and 10 at the voxel's sides. Accordingly, the center of the voxel, after completion of the eighth sequence, does not increase in thickness. The tow-ends of all rows and columns now have the same thickness as the center, and all three-dimensional grid spaces (i.e., spaces defined by rows, columns, and layers) within the voxel are substantially filled with tows of fiber.

It should be noted that the same pattern described in the recipe of FIG. 8 (and/or any other recipe in this disclosure) could be used to form a voxel from more than two ply directions (e.g., more than the described and depicted orthogonal columns and rows), if desired. For example, three (or more) plies that intersect at oblique angles could be built up following any of the recipes of this disclosure. For example, the sequences of any recipe could result in deposition of corresponding tows in each of the three different ply directions to form a triangle, a diamond, or other non-rectangularly shaped voxel (see FIG. 14).

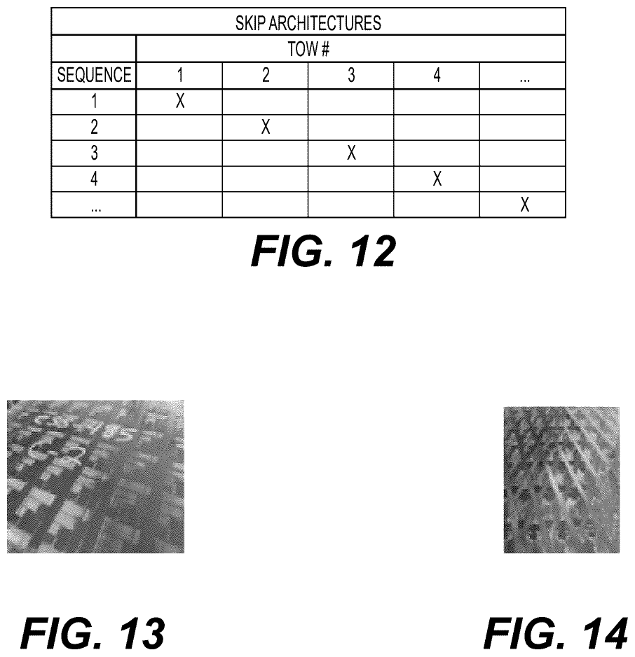

Another example voxel pattern is shown in FIGS. 12-14 that can be repeated to form the distributed network of an exemplary layer 80. FIG. 12 provides a recipe for creating the pattern, while FIGS. 13 and 14 illustrate isometric views of completed patterns. FIG. 13 represents a pattern using two orthogonal ply directions, while FIG. 14 illustrates a pattern using three obliquely oriented ply directions. For the purposes of this disclosure, these patterns may be referred to as Skip Patterns due to repetition of the pattern after skipping any number of rows and columns within a given voxel. For example, the pattern of FIGS. 12 and 13 is shown as including four columns and four rows (i.e., skipping four rows and four columns before repeating the pattern). It is contemplated, however, that the pattern of FIGS. 12 and 13 may be modified to include any number of columns and rows (i.e., that any number of columns and rows may be skipped before repeating the pattern), as desired.

The recipe of FIG. 12 should be understood in the same way as the recipe of FIG. 8. That is, each X in the table represents a tow of reinforcement placed into the corresponding location for each ply (e.g., for each column and row) making up the voxel. Because of this common understanding, the deposition of each tow of material will not be described in detail in regard to the Skip Patterns.

In general, each sequence in the recipe of FIG. 12 may result in one tow of reinforcement being applied in each ply direction. In the example of FIGS. 12 and 13, this includes one column followed by one row of reinforcement, with the row overlapping the column at a single location. Each subsequent sequence may cause each deposited column to overlap each previously deposited row of material at a single location. Likewise, each subsequent sequence may cause each deposited row to overlap each previously deposited column of material at a single location. At conclusion of the recipe of FIG. 12, the resulting voxel will have a consistent thickness of two stacked reinforcements at all locations. It should be noted that, in some applications, an inconsistent thickness may be desired and possible.

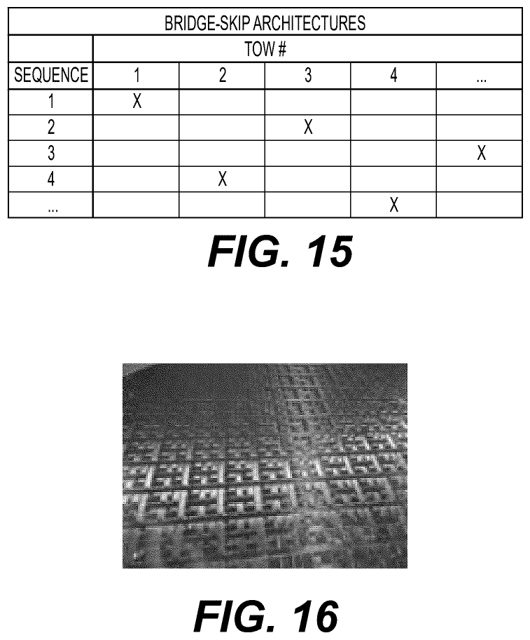

Another example voxel pattern is shown in FIGS. 15 and 16 that can be repeated to form the distributed network of an exemplary layer 80. FIG. 15 provides a recipe for creating the pattern, while FIG. 16 illustrates an isometric view of a completed pattern. For the purposes of this disclosure, this pattern may be referred to as Bridge-Skip Pattern. The pattern of FIGS. 15 and 16 can be tailored to any size pattern by selectively skipping a desired number of columns/rows before repeating. As will be explained in more detail below, the pattern also resembles a bridge in the way that successive columns/rows extend away from a midpoint of a previously deposited path of material. One function of the Bridge-Skip Pattern may be to intentionally alter the sequence away from a standard linear sequence. This creates conditions where the fibers would undulate differently, making the stacking sequence more scattered (e.g., odds then evens). This may help to avoid the last tow in a pattern from needing to go from the highest to lowest positions within a single voxel distance. This may also help each voxel/fiber “seat” more uniformly.

The recipe of FIG. 15 should be understood in the same way as the recipes of FIGS. 8 and 12, and the pattern of FIG. 15 may be considered a modification of the recipe of FIG. 12. Just as in the example of FIG. 12, each sequence in the recipe of FIG. 15 may result in deposition of one column of reinforcement followed by deposition of one corresponding row of reinforcement in an overlapping manner. However, in contrast to the example of FIG. 12, the recipe of FIG. 15 calls for the columns/rows of each subsequent sequence to skip one grid space (i.e., one column and one row) from previously deposited columns/rows of reinforcements, while still overlapping the previously applied tows. Regardless of the size of the voxel selected for fabrication (e.g., 4×4, 5×5, 6×6, etc.), after a first half of the tows (e.g., 2 tows in a 4×4, 3 tows in a 5×5, etc.) have been deposited, the recipe calls for material deposition within the skipped columns and rows. At conclusion of the recipe of FIG. 15, the resulting voxel will have a consistent thickness of two stacked reinforcements at all locations.

It should be noted that, while the Skip Pattern and the Bridge-Skip Pattern may seem similar and each produce a 2-layer voxel stack, the patterns may perform differently when used to fabricate structure 12. For example, the Skip Pattern may have longer lengths of reinforcements with fewer crimps (i.e., locations at which the reinforcements deviate from a generally straight trajectory to move from one layer into another layer) along their lengths. Straighter trajectories may provide a stiffer layer 80, which can resist bending better and/or carry higher tensile loads. Straighter trajectories, in addition to being provided by the Skip Pattern, may also be achieved by having larger voxels (i.e., a greater number of columns/rows). In contrast, a greater number of crimps may provide greater flexibility and greater resistance to interlaminar shearing. It has also been found that the Bridge-Skip Pattern generally produces a more uniform thickness (e.g., less undesired buildup) across layer 80.

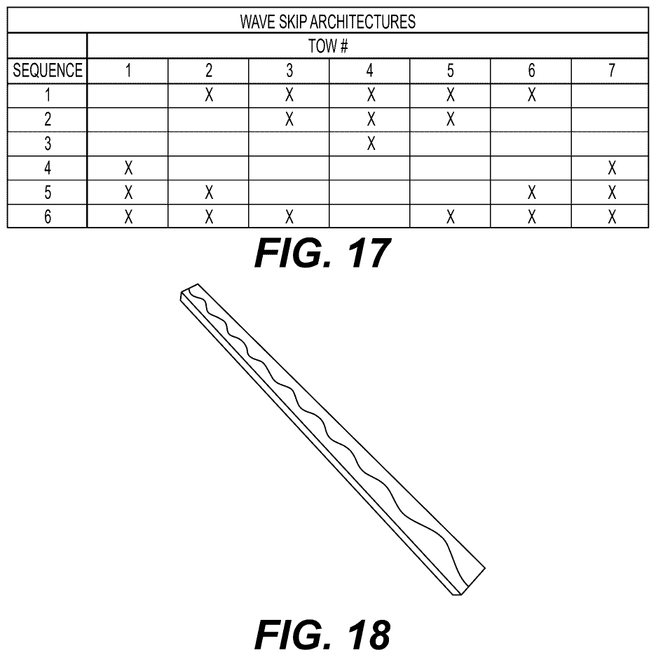

Another example voxel pattern is shown in FIGS. 17 and 18 that can be repeated to form the distributed network of an exemplary layer 80. FIG. 15 provides a recipe for creating the pattern, while FIG. 16 illustrates a cross-sectional view of a completed pattern. For the purposes of this disclosure, this pattern may be referred to as Wave-Skip Pattern. The pattern of FIGS. 17 and 18 can be tailored to any size pattern by selectively skipping a desired number of columns/rows before repeating. As will be explained in more detail below, a cross-section of the pattern (see FIG. 18) also resembles a wave in the way that reinforcements within the pattern undulate from extreme sides (e.g., from front-to-back-to-front through multiple reinforcement thicknesses) of the voxel as they extend transversely through the voxel.

The recipe of FIG. 17 should be understood in the same way as the previously descried recipes. Like the recipe of FIG. 8, the recipe of FIG. 17 may begin by building up a center of the voxel and thereafter filling in the sides of the voxel. By building up the center first, a peak may be created at the center that subsequently deposited reinforcements must summit, thereby creating the wave shown in FIG. 18.

While the recipes of FIGS. 8 and 17 may seem similar in the way they progress, they may perform differently. For example, the voxel created via the recipe of FIG. 8 may have longer sections of reinforcement that are straighter (i.e., without crimps), when compared to the voxel created via the recipe of FIG. 17. As discussed above, fewer crimps may result in greater bending resistance and tensile loading capabilities, while a greater number of crimps and/or undulations that pass through a greater thickness of the voxel may provider a higher interlaminar shear strength.

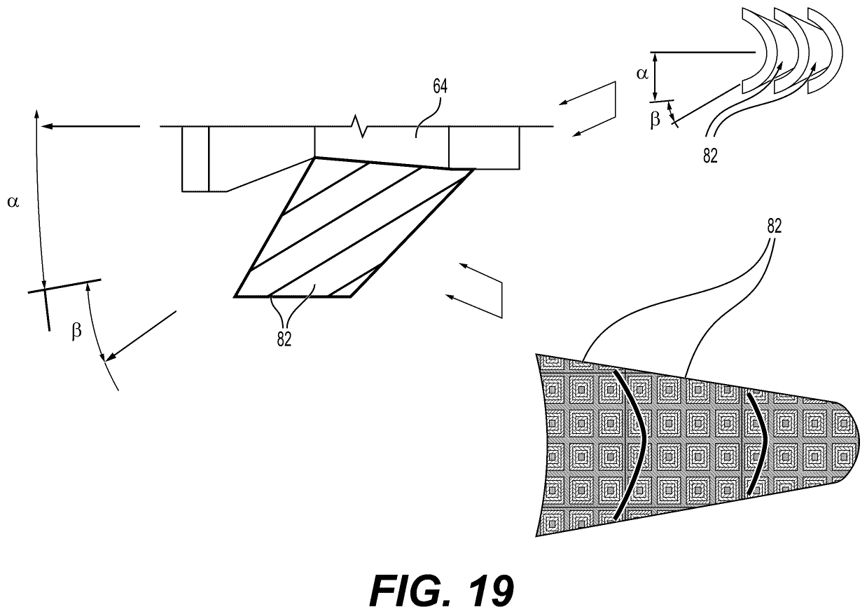

FIG. 19 illustrates another example high-temperature component of structure 12 that may be fabricated via the methods described in this disclosure. In this example, the component is airfoil 64 (referring to FIG. 3). Although airfoil 64 will be described as a single monolithic composite structure, it is contemplated that only a portion (e.g., just a leading edge) of airfoil 64 may be fabricated via the disclosed methods, if desired. Like cone 68, airfoil 64 may be fabricated via CF3D as a CBFC or a CMC.

Preform fabrication of airfoil 64 (or just the leading edge) may include discharging of composite material by head 16 (referring to FIGS. 1, 2, and 5) onto a corresponding tool (not shown). In this embodiment, the tool may or may not rotate, but includes contours that provide a desired geometry of airfoil 64. This may include, for example, contours that at least partially mimic wedge 78 shown in FIG. 5 in order to make shingled layers 82 similar to layers 80 of nose cone 68. Layers 82 may be stacked adjacent each other, from a trailing edge of airfoil 64 towards a leading edge. Layers 82 may have generally consistent thicknesses and variable lengths, depending on a design of airfoil 64.

In one embodiment, the resulting shingled layers 82 may be planar or curved and oriented at a composite angle of (α+β) relative to axis 74 (referring to FIG. 5 and the left-most image of FIG. 19), such that a trailing edge of airfoil 64 is located further away from axis 74 than the leading edge. In the disclosed example, this composite angle may be about equal to 15-40° (e.g., about 20°). In embodiments where layers 82 are curved, opposing side walls of the curvature may additionally be oriented at about the same composite angle relative to a plane of symmetry passing through layer 82 (see upper right image of FIG. 19). It is contemplated that, instead of being curved or a simple plane, each layer 82 may form a V-shape (e.g., be made from two planar surfaces joined together at a line of intersection) if desired. In this latter case, the intersection line may be oriented at the composite angle relative to axis 74, and the associated planar surfaces may each be oriented at the composite angle relative to the plane of symmetry.

Like layers 80, each layer 82 may be formed by selectively interlacing in situ any number of reinforcements in a predefined pattern. It should be noted that, while the pattern disclosed in FIGS. 8-10 is reproduced within FIG. 19 as being used to fabricate layers 82, any of the patterns in this disclosure (and others) may be implemented. The selected pattern may be repeated across the planar surface(s) and/or around the curved surface of a given layer 82 (e.g., end-to-end and/or side-to-side in a continuous manner) to produce a uniformly distributed network of connected voxels. In some applications, a given pattern of interlacing is not repeated within a thickness of a given layer 82 (e.g., in a direction substantially orthogonal to a surface of a given layer). Instead, in some applications, a planar, cylindrical, or other-shaped boundary between adjacent layers 82 may be at least partially defined by repetition of the pattern. It is also contemplated that adjacent layers 82 may be fabricated using different patterns, if desired.

Once the preforms of nose 62 and/or airfoil 64 have been fully densified, the process of fabrication may be completed. That is, structure 12 may have a desired shape and size, without machining being required. In some instances, however, structure 12 may intentionally be oversized, and light machining may be helpful to precisely achieve the desired shape and/or size within a required tolerance.

### INDUSTRIAL APPLICABILITY

The disclosed system may be used to manufacture high-temperature composite structures having any desired cross-sectional shape, length, density, strength, or other performance parameter discussed above. The composite structures may include any number of different reinforcements of the same or different types, diameters, shapes, configurations, and consists, any number and types of different compositions. In addition, the disclosed composite architectures and fabrication methods may allow for extended component life in hypersonic and other high-temperature applications that are normally precluded for CBFC and/or CMC components. Operation of system 10 will now be described in detail.

At a start of a manufacturing event, information regarding a desired structure 12 to be fabricated may be loaded into system 10 (e.g., into memory 42 of processor 36 that is responsible for regulating operation of support 14, head 16, etc.). This information may include, among other things, a size (e.g., diameter, wall thickness, length, etc.), a contour (e.g., a trajectory, fiber pathing, etc.), surface features (e.g., ridge size, location, thickness, length; flange size, location, thickness, length; etc.), connection geometry (e.g., locations and sizes of couplings, tees, splices, etc.), location-specific composition stipulations, location-specific reinforcement stipulations (e.g., interlace patterns), desired cure rates, cure locations, cure parameters, desired pyrolization rates, pyrolization locations, pyrolization parameters, additive specifications, etc. It should be noted that this information may alternatively or additionally be loaded into system 10 at different times, periodically, and/or continuously during the manufacturing event, if desired.

Based on the component information, one or more different (e.g., different sizes, shapes, numbers, and/or types of) reinforcements, compositions, additives, etc. may be selectively installed within system 10 and supplied to head 16. For example, a tow of carbon and/or ceramic fiber may be threaded from module 45 through modules 49, 51, and 52, and a carbon and/or ceramic precursor composition may fill module 47. Processor 36 may then selectively activate the various modules of head 16, such that the continuous reinforcement passing through head 16 is appropriately coated and/or internally wetted with the composition, pulled from head 16, woven into the desired pattern(s) to form layers 80, 82, and cured to at least a green state in the desired preform shape (e.g., shingles) of structure 12. Using any conventional densification process known in the art, the preform of structure 12 may then be suitably pyrolized and densified.

The disclosed system may be used to fabricate composite structures having improved architecture that facilitates travel at hypersonic speeds. These architectures may be fabricated via in situ interlacing, resulting in greater placement accuracy, reduced reinforcement distortion, and little if any slippage. This may help ensure consistent thermal insulation properties and improved resistance to ablation. In addition, the ability to custom-tailor the interlace patterns may result in performance optimized for particular applications. And because the disclosed methods may not require fabrication of sublayers or prior machining of sublayers, the methods may produce lower cost components in shorter time.

It will be apparent to those skilled in the art that various modifications and variations can be made to the disclosed architectures and methods. Other embodiments will be apparent to those skilled in the art from consideration of the specification and practice of the disclosed architectures and methods. It is intended that the specification and examples be considered as exemplary only, with a true scope being indicated by the following claims and their equivalents.

What is claimed is:

1. A method of fabricating a high-temperature composite structure, comprising:
in situ interlacing a composition-coated reinforcement in a predefined pattern to form a plurality of shingles stacked adjacent each other; and
hardening the composition in the composition-coated reinforcement.

2. The method of claim 1, wherein:
the high-temperature composite structure includes a nose cone; and
in situ interlacing includes interlacing the composition-coated reinforcement to form a uniformly distributed network of the pattern revolved around a central axis.

3. The method of claim 2, wherein teach of the plurality of shingles is oriented at an oblique angle relative to the central axis.

4. The method of claim 3, wherein the oblique angle is about 15-40°.

5. The method of claim 1, wherein:
the high-temperature composite structure includes an airfoil for a vehicle; and
in situ interlacing includes interlacing the composition-coated reinforcement to form a uniformly distributed network of the pattern across a leading edge of the airfoil.

6. The method of claim 5, wherein the each of the plurality of shingles is generally planar.

7. The method of claim 6, wherein each of the plurality of shingles is oriented at an oblique angle relative to a central axis of the vehicle.

8. The method of claim 5, wherein each of the plurality of shingles is V-shaped.

9. The method of claim 8, wherein:
the V-shape is made up of intersecting planes; and
a line of intersection between the intersecting planes is oriented at an oblique angle relative to a central axis of the vehicle.

10. The method of claim 5, wherein:
each of the plurality of shingles is curved; and
side walls of the curved plurality of shingles are oriented at an oblique angle relative to a plane of symmetry passing through an associated curvature.

11. The method of claim 1, wherein:
the reinforcements are continuous carbon or ceramic fibers; and
the composition is one of a carbon precursor or a ceramic precursor.

12. The method of claim 1, further including:
densifying the preform; and
pyrolizing the densified preform.

13. The method of claim 1, wherein the pattern includes the composition-coated reinforcements overlapping from at least two different ply directions.

14. The method of claim 13, wherein the pattern forms a voxel having all internal grid spaces substantially filled.

15. The method of claim 14, wherein the voxel has a thickness equal to a multiple of a thickness of the composite-coated reinforcement.

16. The method of claim 15, wherein:
the ply directions are columns and rows; and
the columns and rows interlace over and under each other.

17. The method of claim 13, wherein the pattern is produced only once in a thickness direction of each of the plurality of shingles.

18. The method of claim 13, wherein adjacent ones of the plurality of shingles are separated by a boundary that is at least partially defined by repetition of the pattern.

19. The method of claim 13, wherein the pattern is one of a 3D Checkerboard Wave Pattern, a Skip Pattern, a Bridge-Skip Pattern, or a Wave Skip Pattern.

20. A high-temperature composite component, comprising:
a preform having reinforcements coated with a composition,
wherein the reinforcements are woven via the method of claim 1 into shingles stacked adjacent to each other.
